(19) United States
(12) Patent Application Publication
(10) Pub. No.: US 2024/0308813 A1
(43) Pub. Date: Sep. 19, 2024

(54) System and Method for Controlling Motion of a Bank of Elevators

(71) Applicant: Mitsubishi Electric Research Laboratories, Inc., Cambridge, MA (US)

(72) Inventors: Jing Zhang, Cambridge, MA (US); Abhishek Sharma, Cambridge, MA (US); Daniel Nikovski, Cambridge, MA (US)

(21) Appl. No.: 18/183,512

(22) Filed: Mar. 14, 2023

(51) Int. Cl. B66B 1/24; B66B 1/28

(52) U.S. Cl. CPC B66B 1/2458; B66B 1/28; B66B 2201/212; B66B 2201/214; B66B 2201/231

(57) ABSTRACT

The present disclosure provides a system and a method for controlling motion of a bank of elevators. The method includes accepting current requests for service by the bank of elevators, accepting a partial trajectory of a motion of a person moving in an environment serviced by the bank of elevators, and obtaining a probability of a future elevator request. The method further includes processing the partial trajectory with a neural network trained to estimate a weighted combination of probability density functions that indicates an arrival time distribution of the person, and generating a set of possible future requests jointly representing the probability of the future elevator request and the arrival time distribution. The method further includes optimizing a schedule of the bank of elevators to serve the current requests and the set of possible future requests, and controlling the bank of elevators according to the schedule.

### TECHNICAL FIELD

The present disclosure relates generally to elevators, and more specifically to a system and method for controlling motion of a bank of elevators.

### BACKGROUND

Elevator or a bank of elevators is installed in a building that includes multiple floors. Users use the bank of elevators to move from one floor to another floor in the building. Elevator scheduling is an important aspect for ensuring efficient operation of the bank of elevators, e.g., to reduce wait times of the users. Generally, current elevator requests are received from the users, and based on the current elevator requests a schedule is determined to control the bank of elevators. However, to determine an optimal schedule for the bank of elevators that minimizes an average waiting time for all the users, it is required to consider future elevator requests. To consider the future elevator requests, arrival time of potential future passengers is to be predicted. The arrival time refers to an amount of time that a user may take to reach the bank of elevators.

Some approaches use model based methods to predict the arrival time. The model-based methods either use queuing theory or agent-based modeling to build simulators for users' movement. Models used by the model-based methods make assumptions about movement flow, speed, and density of the users. The models used by the model-based methods are inherently generative models, thus sampling user trajectories from the models is relatively straightforward. However, sampling trajectories is slow and expensive. Further, performance degrades for longer-duration simulations. Furthermore, precise calibration of physical models may be slow and laborious.

Accordingly, there is still a need for a method and a system for optimal scheduling and controlling of the bank of elevators.

### SUMMARY

It is an objective of some embodiments to provide a system and a method for predicting arrival times of future passengers to an elevator of a bank of elevators. Specifically, it is an object to some embodiments to predict probabilistic distributions of the arrival times of the future passengers. It is also an objective of some embodiments to obtain probability of elevator requests of the future passengers (i.e., future elevator requests), and determine continuations of future passengers' arrival streams based on the obtained the probability of future elevator requests and the predicted probabilistic distributions of the arrival times of the future passengers. Additionally, it is also an objective of some embodiments to determine a schedule for the bank of elevators based on the continuations of future passengers' arrival streams, where the schedule optimizes a performance metric by minimizing an Average Waiting Time (AWT) for all passengers.

Generally, current elevator requests are received from the passengers for service by a bank of elevators, and based on the current elevator requests, a schedule for the bank of elevators is determined. However, to determine an optimal schedule for the bank of elevators, it is desired to consider future elevator requests, in addition to the current elevator requests. For example, a first passenger on a sixth floor of a building requests service from the bank of elevators to go to first floor of the building. Consider that an elevator car assigned to provide service to the first passenger is currently at fifteenth floor. Consider that in next five seconds a second passenger on tenth floor will also request the service to go the first floor. In this case, an elevator scheduler determines beforehand such arrival information associated with future passenger i.e. the second passenger and may determine a schedule such that the elevator car on the fifteenth floor may wait for five seconds till the future passenger i.e. the second passenger requests the service to go to the first floor. On reception of the request from the second passenger, the elevator car may first pick up the second passenger from the tenth floor and then may pick the first passenger on the sixth floor, accordingly both the passengers may arrive on the first floor together. Thus, it is desired to consider the future elevator requests to further optimize the AWT of the passengers.

To consider the future elevator requests, it is required to determine a probability that a passenger reaches the elevator for elevator service, and a probability of an amount of time that the passenger may take to reach the elevator. The probability that the passenger reaches the elevator for the elevator service may be referred to as a probability of future elevator request. The amount of time that the passenger may take to reach the elevator is referred to as the arrival time.

A problem of determining the probability of the future elevator request is referred to as a future service request problem. A problem of determining the probability of the arrival time is referred to as an arrival time prediction problem. Some embodiments are based on the realization that future service request problem and the arrival time prediction problem can be contemplated as separate and independent problems. For example, the probability of the passenger reaching the elevator is determined independently, and the probability of the arrival time is also predicted independently with an assumption that the passenger will reach the elevator. Since the future service request problem and the arrival time prediction problem are contemplated as separate problems, each of the problems can be solved with different approaches.

For example, in some embodiments, given a current position and destination of the passenger, the arrival time of the passenger can be predicted using a neural network. However, given the current position and the destination, the passenger can take multiple paths to reach the destination (e.g., one passenger from the current position may first go to some intermediate location (the restroom, for instance) and then head to the elevator, thus taking a bit longer than directly heading to the elevator). Such multi-modality in the arrival time needs to be considered to accurately predict the arrival time. Some embodiments are based on the realization that a probabilistic distribution of the arrival time can be predicted to account for the multi-modality in the arrival time.

To that end, some embodiments of the present disclosure disclose a Neural Travel-time Mixture Model (NTMM) to predict the probabilistic distribution of the arrival time. NTMM is trained to estimate a weighted combination of probability density functions such that the weighted combination of probability density functions indicates an arrival time distribution of the passenger arriving to the elevator by one of the multiple paths. The weighted combination of probability density functions predicted by NTMM is advantageous, because the resulting distribution can be used to evaluate a conditional cumulative distribution function and to generate samples, in addition to evaluating probability density.

Further, in an embodiment, the probability of the future elevator request is determined by using an attention-based destination predictor having an encoder-decoder structure. The attention-based destination predictor may be implemented using a transformer architecture based neural network. Alternatively, in some embodiments, the probability of the future elevator request is determined by using a Recurrent Neural Network (RNN). Additionally or alternatively, in some embodiments, the future elevator request is directly obtained. For example, in an office space of an organization, a user may be provided with a user interface at his seat location (or in his cabin) to raise an elevator service request. The user may raise the elevator service request via the user interface.

The determined probability of the future elevator request and the predicted probabilistic distribution of the arrival time can be used to determine the optimal schedule for the bank of elevators. However, it is challenging to directly incorporate the determined probability of the future elevator request and the predicted probabilistic distribution of the arrival time, in determining the optimal schedule. Some embodiments are based on the realization that continuations of future passenger's arrival streams (also referred to as ‘a set of possible future requests’) can be generated based on the determined probability of the future elevator request and the predicted probabilistic distribution of the arrival time. Further, based on the continuations of future passenger's arrival streams, the optimal schedule may be determined. Further, the bank of elevators is controlled according to the optimized schedule to serve both the current elevator requests and the future elevator requests.

Accordingly, one embodiment discloses a control system for controlling motion of a bank of elevators, comprising: at least one processor; and a memory having instructions stored thereon that cause the at least one processor of the control system to: accept one or multiple current elevator requests for service by the bank of elevators; accept a partial trajectory of a motion of a person moving in an environment serviced by the bank of elevators; obtain a probability of a future elevator request; process the partial trajectory with a neural network trained to estimate a weighted combination of probability density functions, wherein the weighted combination of probability density functions indicates an arrival time distribution of the person arriving to the bank of elevators by one of multiple paths in the environment; generate a set of possible future requests jointly representing the probability of the future elevator request and the arrival time distribution; optimize a schedule of the bank of elevators to serve the one or multiple current elevator requests and the set of possible future requests; and control the bank of elevators according to the schedule.

Accordingly, another embodiment discloses a method for controlling motion of a bank of elevators, the method comprising: accepting one or multiple current elevator requests for service by the bank of elevators; accepting a partial trajectory of a motion of a person moving in an environment serviced by the bank of elevators; obtaining a probability of a future elevator request; processing the partial trajectory with a neural network trained to estimate a weighted combination of probability density functions, wherein the weighted combination of probability density functions indicates an arrival time distribution of the person arriving to the bank of elevators by one of multiple paths in the environment; generating a set of possible future requests jointly representing the probability of the future elevator request and the arrival time distribution; optimizing a schedule of the bank of elevators to serve the one or multiple current elevator requests and the set of possible future requests; and controlling the bank of elevators according to the schedule.

Accordingly, yet another embodiment discloses a non-transitory computer-readable storage medium embodied thereon a program executable by a processor for performing a method for controlling motion of a bank of elevators, the method comprising: accepting one or multiple current elevator requests for service by the bank of elevators; accepting a partial trajectory of a motion of a person moving in an environment serviced by the bank of elevators; obtaining a probability of a future elevator request; processing the partial trajectory with a neural network trained to estimate a weighted combination of probability density functions, wherein the weighted combination of probability density functions indicates an arrival time distribution of the person arriving to the bank of elevators by one of multiple paths in the environment; generating a set of possible future requests jointly representing the probability of the future elevator request and the arrival time distribution; optimizing a schedule of the bank of elevators to serve the one or multiple current elevator requests and the set of possible future requests; and controlling the bank of elevators according to the schedule.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A illustrates a schematic diagram illustrating controlling of motion of a bank of elevators, according to an embodiment of the present disclosure.

FIG. 1B illustrates a block diagram of a control system for controlling the motion of the bank of elevators, according to an embodiment of the present disclosure.

FIG. 1C illustrates a graph illustrating an arrival time distribution and an empirical Probability Density Function (PDF) of samples drawn from the arrival time distribution, according to an embodiment of the present disclosure.

FIG. 2 illustrates training of a Neural Travel-time Mixture Model (NTMM), according to some embodiments of the present disclosure.

FIG. 3A illustrates a layout of a floor in a building with trajectories used for training the NTMM, according to some embodiments of the present disclosure.

FIG. 3B illustrates retraining of the trained NTMM, according to some embodiments of the present disclosure.

FIG. 4A illustrates a block diagram of a transformer architecture based neural network, according to some embodiments of the present disclosure.

FIG. 4B illustrates a schematic showing a Long Short-Term Memory (LSTM) based neural network, according to some embodiments of the present disclosure.

FIG. 5 illustrates a schematic of a floor plan of a building, according to some embodiments of the present disclosure.

FIG. 6 illustrates a flow diagram of a method for controlling motion of bank of elevators, according to an embodiment of the present disclosure.

FIG. 7 is a schematic illustrating a computing device for implementing the methods and the control system of the present disclosure

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

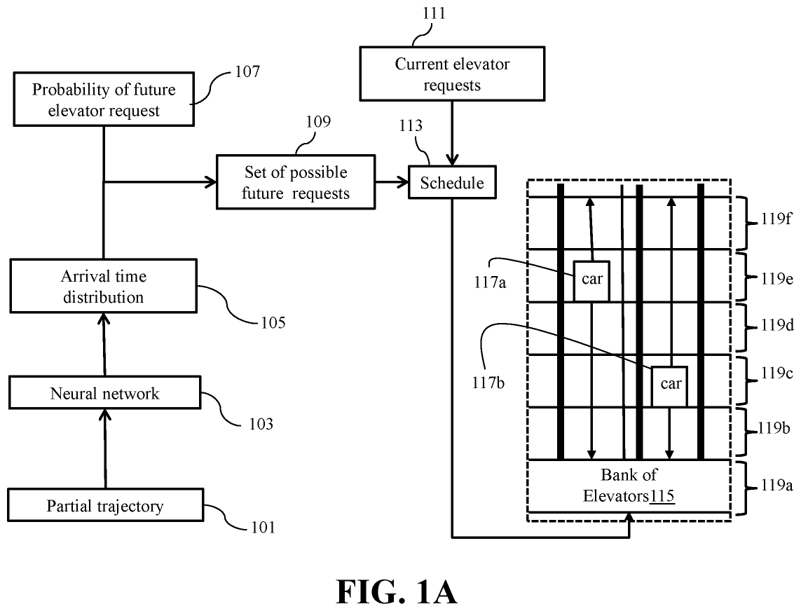

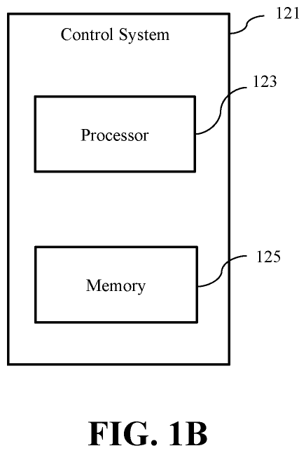

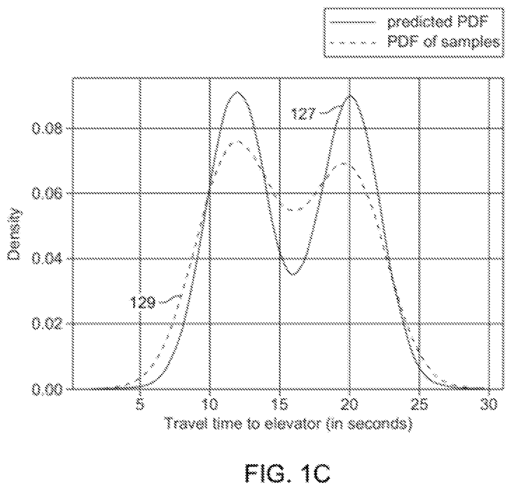

FIG. 1A shows a schematic diagram illustrating controlling of motion of a bank of elevators 115, according to an embodiment of the present disclosure. The bank of elevators 115 may include one or more elevator cars, such as a car 117a, and a car 117b. The bank of elevators 115 may be installed in an environment, e.g., a building including multiple floors, such as, a floor 119a, a floor 119b, a floor 119c, a floor 119d, a floor 119e, and a floor 119f. It is an object of some embodiments provide a control system for determining an optimal schedule for the bank of elevators 115, where the optimal schedule optimizes a performance metric by minimizing an Average Waiting Time (AWT) for all passengers. It is also an object of some embodiments to provide a control system for controlling the bank of elevators 115, based on the optimal schedule. Such a control system is described below in FIG. 1B.

FIG. 1B shows a block diagram of a control system 121 for scheduling and controlling the bank of elevators 115, according to an embodiment of the present disclosure. The control system 121 includes a processor 123 and a memory 125. The processor 123 may be a single core processor, a multi-core processor, a computing cluster, or any number of other configurations. The memory 125 may include random access memory (RAM), read only memory (ROM), flash memory, or any other suitable memory systems. Additionally, in some embodiments, the memory 125 may be implemented using a hard drive, an optical drive, a thumb drive, an array of drives, or any combinations thereof.

The processor 123 accepts a partial trajectory 101 of a motion of a person moving (who may be a potential passenger) in the environment serviced by the bank of elevators 115. The partial trajectory 101 of the motion of the person may correspond to a portion of the path covered by the person while going from an origin to a destination. The partial trajectory 101 may depend upon the path taken by the person. For example, the partial trajectory 101 may be straight or curved or zigzag depending upon the path taken by the person. The environment serviced by the bank of elevators 115 may be an area on the floor of the multiple floors (119a to 119f). In an embodiment, the processor 123 may use sensors (e.g., camera or the like) associated with the environment to capture movements of the person in order to determine the partial trajectory 101.

Further, the processor 123 accepts current elevator requests 111 from the passengers for service by the bank of elevators 115, and determines a schedule for the bank of elevators 115 based on the current elevator requests. However, to determine an optimal schedule for the bank of elevators 115, it is desired to consider future elevator requests, in addition to the current elevator requests 111. For example, a first passenger on a sixth floor of a building requests service from the bank of elevators to go to first floor of the building. Consider that an elevator car assigned to provide service to the first passenger is currently at fifteenth floor. Consider that in next five seconds a second passenger on tenth floor will also request the service to go the first floor. In this case, an elevator scheduler determines beforehand such arrival information associated with future passenger i.e. the second passenger and may determine a schedule such that the elevator car on the fifteenth floor may wait for five seconds till the future passenger i.e. the second passenger requests the service to go to the first floor. On reception of the request from the second passenger, the elevator car may first pick up the second passenger from the tenth floor and then may pick the first passenger on the sixth floor, accordingly both the passengers may arrive on the first floor together. Thus, it is desired to consider the future elevator requests to further optimize the AWT of the passengers.

To consider the future elevator requests, it is required to determine a probability that a passenger reaches the bank of elevators 115 for elevator service, and a probability of an amount of time that the passenger may take to reach the bank of elevators 115. The probability that the passenger reaches the bank of elevators 115 for the elevator service may be referred to as a probability of future elevator request. The amount of time that the passenger may take to reach the bank of elevators 115 is referred to as an arrival time.

A problem of determining the probability of the future elevator request is referred to as a future service request problem. A problem of determining the probability of the arrival time is referred to as an arrival time prediction problem. Some embodiments are based on the realization that future service request problem and the arrival time prediction problem can be contemplated as separate and independent problems. For example, the probability of the passenger reaching the bank of elevators 115 is determined independently, and the probability of the arrival time is also predicted independently with an assumption that the passenger will reach the bank of elevators 115. Since the future service request problem and the arrival time prediction problem are contemplated as separate problems, each of the problems can be solved with different approaches.

For example, in some embodiments, given a current position and destination of the passenger, the arrival time of the passenger can be predicted using a neural network. However, given the current position and the destination, the passenger can take multiple paths to reach the destination (e.g., one passenger from the current position may first go to some intermediate location (the restroom, for instance) and then head to the elevator, thus taking a bit longer than directly heading to the elevator). Such multi-modality in the arrival time needs to be considered to accurately predict the arrival time. Some embodiments are based on the realization that a probabilistic distribution of the arrival time can be predicted to account for the multi-modality in the arrival time.

To that end, some embodiments of the present disclosure disclose a neural network 103 trained to estimate a weighted combination of probability density functions such that the weighted combination of probability density functions indicates an arrival time distribution of the passenger arriving to the elevator by one of the multiple paths. The processor 123 processes the partial trajectory 101 with the neural network 103 to estimate a weighted combination of probability density functions that indicates an arrival time distribution 105 of the person arriving to the bank of elevators 115 by one of the multiple paths. The weighted combination of probability density functions predicted by the neural network 103 is advantageous, because the resulting distribution can be used to evaluate a conditional cumulative distribution function and to generate samples, in addition to evaluating probability density.

Further, the processor 123 obtains a probability of future elevator request 107. In an embodiment, to obtain the probability of the future elevator request 107, the processor 123 processes the partial trajectory 101 with an attention-based destination predictor having an encoder-decoder structure. The attention-based destination predictor may be implemented using a transformer architecture based neural network. Alternatively, in some embodiments, to obtain the probability of the future elevator request 107, the processor 123 processes the partial trajectory 101 with a Recurrent Neural Network (RNN).

The probability of the future elevator request 107 and the arrival time distribution 105 can be used to determine the optimal schedule for the bank of elevators 115. However, it is challenging to directly incorporate the probability of the future elevator request 107 and the arrival time distribution 105, in determining the optimal schedule. Some embodiments are based on the realization that a set of possible future requests can be generated based on the probability of the future elevator request 107 and the arrival time distribution 105. To that end, the processor 123 generates a set of possible future requests 109 jointly representing the probability of the future elevator request 107 and the arrival time distribution 105. An example of generation of the set of possible future requests 109 is explained below.

Consider an eight-floor building and each floor (indicated by 1 through 8) includes one elevator bank. Starting time is t₀=5:00:00 pm. A current elevator request is {(5:00:00 pm, 8,1)}. With a prediction duration T=30 seconds, the following future arrival information is extracted by using the transformer architecture based neural network and the neural network 105: on floor 7, passenger 1 from source 2 is predicted to arrive at the bank of elevators 115 with probability 0.8 in ΔT seconds, where ΔT follows the arrival time distribution 105. 16 values are sampled from the arrival time distribution 105 for ΔT: [19.4,9.8,19.9,12.7,16.8,19.7,11.7,21.0,12.2,21.1,10.5,17.3,21.2,13.9,11.1,12.3], and 20 continuations of the passenger's arrival streams that form the set of possible future requests 109 can be generated by Monte Carlo simulation as follows:

{(5:00:00 pm, 8, 1)}
{(5:00:00 pm, 8, 1)}
{(5:00:00 pm, 8, 1)}
{(5:00:00 pm, 8, 1)}
{(5:00:00 pm, 8, 1), (5:00:19.4 pm, 7, 1)}
{(5:00:00 pm, 8, 1), (5:00:9.8 pm, 7, 1)}
{(5:00:00 pm, 8, 1), (5:00:19.9 pm, 7, 1)}
{(5:00:00 pm, 8, 1), (5:00:12.7 pm, 7, 1)}
{(5:00:00 pm, 8, 1), (5:00:16.8 pm, 7, 1)}
{(5:00:00 pm, 8, 1), (5:00:19.7 pm, 7, 1)}
{(5:00:00 pm, 8, 1), (5:00:11.7 pm, 7, 1)}
{(5:00:00 pm, 8, 1), (5:00:21.0 pm, 7, 1)}
{(5:00:00 pm, 8, 1), (5:00:12.2 pm, 7, 1)}
{(5:00:00 pm, 8, 1), (5:00:21.1 pm, 7, 1)}
{(5:00:00 pm, 8, 1), (5:00:10.5 pm, 7, 1)}
{(5:00:00 pm, 8, 1), (5:00:17.3 pm, 7, 1)}
{(5:00:00 pm, 8, 1), (5:00:21.2 pm, 7, 1)}
{(5:00:00 pm, 8, 1), (5:00:13.9 pm, 7, 1)}
{(5:00:00 pm, 8, 1), (5:00:11.1 pm, 7, 1)}
{(5:00:00 pm, 8, 1), (5:00:12.3 pm, 7, 1)}

Further, the processor 123 optimizes a schedule 113 of the bank of elevators to serve the current elevator requests 111 and the set of possible future requests 109. The processor 123 controls the bank of elevators 115 according to the optimized schedule 113.

The arrival time distribution 105 estimated by the neural network and an empirical Probability Density Function (PDF) of the samples drawn from the arrival time distribution 105 is shown in FIG. 1C.

FIG. 1C shows a graph 127 illustrating the arrival time distribution 105 and an empirical PDF 129 of the samples drawn from the arrival time distribution 105, according to some embodiments of the present disclosure.

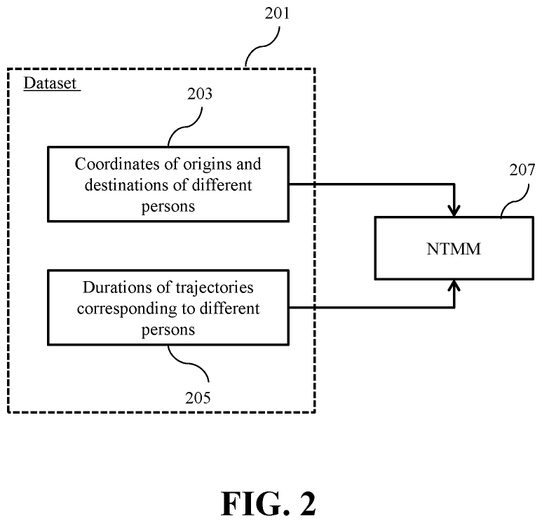

In an embodiment, the neural network 105 trained to estimate the weighted combination of probability density functions that indicates the arrival time distribution 105, is a Neural Travel-time Mixture Model (NTMM). The NTMM is trained based on a dataset, as described below in FIG. 2A.

### Training of NTMM

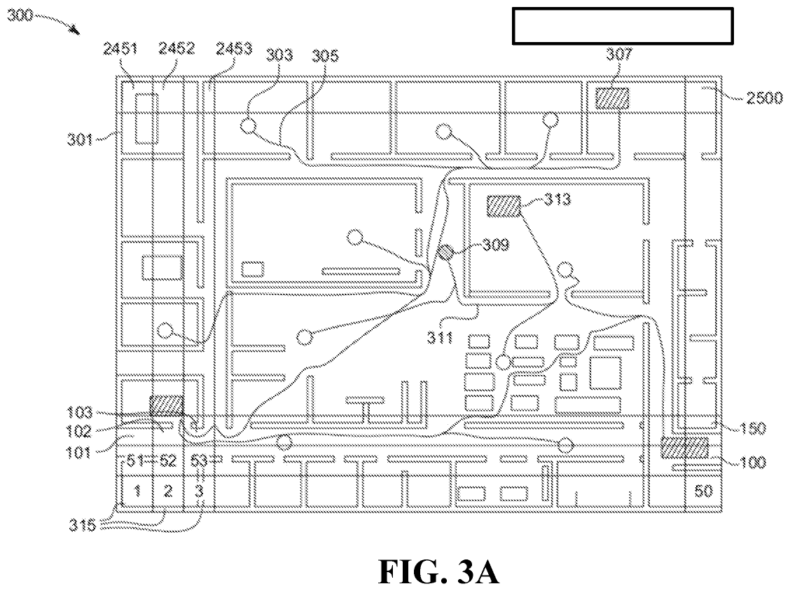

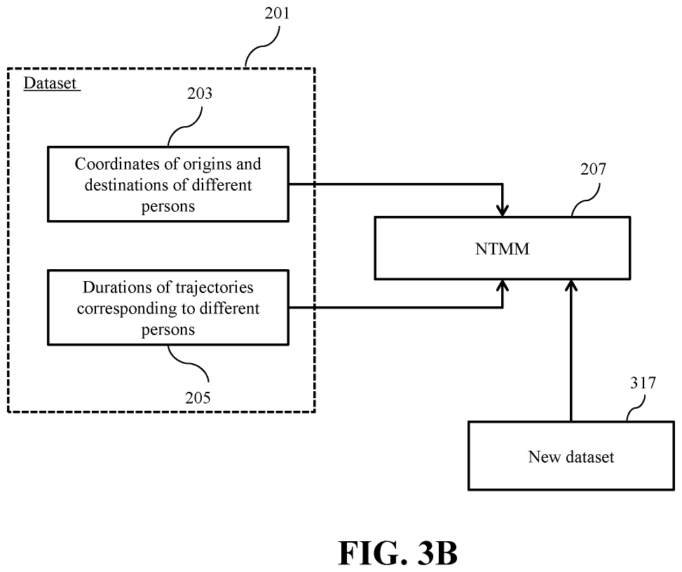

FIG. 2 illustrates the training of NTMM 207, according to some embodiments of the present disclosure. The NTMM 207 is trained with a dataset 201 including coordinates of origins and destinations 203 of different persons, and durations of trajectories 205 corresponding to the different persons. Additionally or alternatively, the dataset 201 includes durations of trajectories corresponding to the same person at different times. The trajectories used for training the NTMM 207 are described below in FIG. 3A.

FIG. 3A illustrates a layout 300 of a floor 301 in a building with trajectories used for training the NTMM 207, according to some embodiments of the present disclosure. In some embodiments, each trajectory, such as a trajectory 305 and a trajectory 311, may be represented by a sequence of tessellation indices. Each trajectory may have its own origin and destination. For example, the trajectory 305 includes an origin 303 and a destination 307, and the trajectory 311 includes an origin 309 and a destination 313. The tessellation indices may be obtained by discretizing a range of positional co-ordinates, where a range of positional co-ordinates may represent longitudes and latitudes associated with the tessellation indices corresponding to the floor 301. In another embodiment, the trajectories may comprise trajectories including both positional information and timing information. Further, each trajectory may be represented by a sequence of tuples of tessellation indices, where each tuple may include tessellation indices obtained by discretizing a range of positional co-ordinates and a period of prediction.

As shown in FIG. 3A, coordinates of positions on the floor 301 are discretized into tessellation indices 1 to 2500, thus simplifying representations of the trajectories. The tessellation indices 1 to 2500 are collectively shown by 315. Space of the floor 301 is discretized into a 50×50 tessellation and each trajectory is converted into a sequence of tessellation locations. Such a trajectory may serve to mimic a single person's movement throughout a floor during a time period of a day where visited destinations may represent mostly accessed real-life indoor destinations such as bathrooms, stairs, elevators, and break rooms. Mathematically, the trajectories are given as explained below.

In an example embodiment, given a set of positional coordinates {(xₗ,yₗ); l=1, 2, . . . , L}, where x's and y's denote longitudes and latitudes respectively. Let xₘᵢₙ=min_{∈{1, 2, . . . , L}}xₗ, xₘₐₓ=max_{l∈{1, 2, . . . , L}}xₗ, yₘᵢₙ=min_{l∈{1, 2, . . . , L}}yₗ, yₘₐₓ=max_{l∈{1, 2, . . . , L}}yₗ. Then, tessellation index pₗ of any given tuple of coordinates (xₗ,yₗ) in an N_{X}×N_{Y} rectangle can be determined as pₗ=\tilde{y}N_{X}+\tilde{x}+1, where

$$\tilde{x} = ⌊ \frac{{x}_{l} - {x}_{min}}{Δ x} ⌋ and \tilde{y} = ⌊ \frac{{y}_{l} - {y}_{min}}{Δ y} ⌋ ,$$

where quantization interval

$$Δ x = \frac{{x}_{max} - {x}_{min}}{X}$$

and quantization interval

$$Δ y = \frac{{y}_{max} - {y}_{min}}{{N}_{Y}} .$$

Positive integers N_{X} and N_{Y} may be taken reasonably large, as long as computational resources permit. Further, N_{X} and N_{Y} may be determined by use of cross-validation, given a set of trajectories.

To that end, the trajectory can be denoted as

$$S = ( {p}_{1} , {p}_{2} , … , {p}_{n} ) ,$$

where n is a length of the trajectory, and last entry pₙ corresponds to the destination.

In some embodiments, both indices for longitudes and latitudes are used. For example, for the tuple of coordinates (xₗ,yₗ), the tessellation index pₗ₁ (resp., pₗ₂) for the longitude (resp., latitude) is determined as pₗ₁=\tilde{x}+1 (resp., pₗ₂=\tilde{y}+1). Therefore, the same trajectory S is represented as:

$$S = ( ( {p}_{11} , {p}_{12} ) , ( {p}_{21} , {p}_{22} ) , … , ( {p}_{n 1} , {p}_{n 2} ) ) .$$

The trajectories in the dataset 201 are represented as the trajectory S. Using the dataset 201, the NTMM 207 learns a conditional probability density, p(T|X). The conditional probability density can be parameterized by a model with parameter θ, that can be optimized using maximum likelihood estimation. Further, a probability density function, p(⋅|X) and a cumulative distribution function, F (⋅|X) may be evaluated to enable a variety of applications using the PDF.

The probability density of a target variable Y can be represented as a weighted combination of individual probability densities as:

$$p ( Y \vert X ) = {\sum }_{k = 1}^{K} {w}_{k} ( X ) {ϕ}_{k} ( Y \vert X ) \qquad ( 1 )$$

where X is an input variable. wₖ is weight and ϕₖ is Gaussian or normal component. In the present disclosure, individual Gaussian PDF or normal distribution is used. Output of the NTMM 207 is therefore K sets of weights, wₖ, means, μₖ, and standard deviations, σₖ.

Since the arrival times are positive, a mixture density network is used to model the arrival times in log space before using an exponential transformation to determine the probability distribution for the arrival times. By change-of-variables over the expression (1) for the probability distributions, the probability density for a time variable T can be determined as

$$\begin{matrix}p ( T \vert X ) = \frac{p ( log T \vert X )}{T} \\ = {\sum }_{k = 1}^{K} {w}_{k} ( X ; θ ) {ϕ}_{k} ( log T \vert X ; θ ) / T\end{matrix}$$

Here, θ denotes parameters of the NTMM 207. As mentioned above, ϕₖ denotes the Gaussian PDF computed using the means, μₖ and standard deviations, σₖ. Mixture density p(T|X) may be used to evaluate the conditional cumulative distribution function (CDF), F(T|X) and further to generate samples, Tᵢ˜p(T|X), in addition to evaluating the probability density.

The CDF can be evaluated as:

$$F ( T \vert X ) = {\sum }_{k = 1}^{K} {w}_{k} {Φ}_{k} ( log T \vert X ; {μ}_{k} , {σ}_{k} )$$

where, Φₖ is the CDF for the Gaussian distribution. A sample Tᵢ from the mixture density p(T|X) can be generated using implied generative distribution:

Z˜Cat(w₁, . . . ,w_{K})

Y˜ [symbol] (μ_{Z},σ_{Z})

T←exp(Y)

where, Cat(⋅) and [symbol] (⋅) are Categorical and Gaussian distributions, respectively.

Given a dataset [symbol] ={(Xₙ,Tₙ)} including the origin and destination coordinates (Xₙ) and duration (Tₙ) of trajectory n, i.e, X={Xₙ}ₙ₌₁^{N} and durations T={Tₙ}ₙ₌₁^{N}, a log-likelihood function of the NTMM 207 is:

$$log p ( T \vert X ; θ ) = {\sum }_{n = 1}^{N} log p ( {T}_{n} \vert {X}_{n} ; θ )$$

The parameters of the NTMM 207 are learnt by maximizing the log-likelihood function, and using a regularization term that includes priors for {πₖ} and {σₖ}. The resulting objective is:

$$\begin{matrix}{max}_{θ} & log ( {\sum }_{k = 1}^{K} {w}_{k} ( {X}_{n} ; θ ) {ϕ}_{k} ( {Y}_{n} \vert {X}_{n} ; θ ) ) \\ & + λ {\sum }_{k = 1}^{K} ( log p ( {π}_{k} ( {X}_{n} ; θ ) ) + log p ( {σ}_{k} ( {X}_{n} ; θ ) ) )\end{matrix}$$

To this end, hyperparameters in the objective are (a) a number of components (K), (b) regularization penalty (λ), (c) a number of nodes in two dense layers, and (d) a learning rate.

Some embodiments based on the recognition that the trajectories of the different persons may change over time. In other words, persons' movement in the environment change over time. Therefore, the trained NTMM 207 requires to be retrained on new dataset, e.g., on movement patterns for which the hyperparameters are not optimal anymore.

FIG. 3B illustrates retraining of the trained NTMM 207, according to some embodiments of the present disclosure. The NTMM 207 trained with the dataset 201 is further retrained with a new dataset 317 to obtain an updated NTMM. The new dataset 317 includes durations of updated trajectories corresponding to the different persons. Since the NTMM 207 is retrained by using the previous hyperparameters, an expensive hyperparameter search is not performed every time the NTMM 207 is retrained. In such a way, the NTMM 207 is trained in a computationally inexpensive manner.

The NTMM 207 to estimates the weighted combination of probability density functions that indicates the arrival time distribution 105. Based on the arrival time distribution and the probability of the future elevator request 107, the processor 123 generates the set of possible future requests 109 as described below.

### Generation of the Set of Possible Future Requests

Denote by H={h₁, h₂, . . . , h_{J}} a set of passengers arriving during an interval of time, where a passenger hᵢ can be indicated by a tuple (τᵢ, oᵢ, dᵢ), where τᵢ is the arrival time, oᵢ is an arrival floor, and dᵢ is a destination floor. Let H(t) be a set of passengers who have arrived by time t, who have not been served yet and are still waiting, W(H(t)) a cumulative waiting time of the passengers in H(t), W_{c}(⋅|⋅) a function that expresses the waiting time of one or more passengers given that another set of zero or more passengers are also assigned to the same car e.g., the car 117a. Denote by H_{c}(t) a set of passengers who are already assigned to the car 117a by time t, but have not been served yet and are still waiting, ΔW_{c}(h)≡W_{c}(H_{c}(t)∪h|H_{c}(t)∪h)−W_{c}(H_{c}(t)|H_{c}(t)) a marginal increase in the waiting time for passenger h when assigned to the car 117a can be determined as follows:

$$Δ {W}_{c} ( h ) = {W}_{c} ( h \vert {H}_{c} ( t ) ) + {\sum }_{g ∈ {H}_{c} ( t )} [ {W}_{c} ( g \vert {H}_{c} ( t ) ⋃ h ) - {W}_{c} ( g \vert {{H}_{}}_{c} ( t ) ) ] ,$$

where, term W_{c}(h|H_{c}(t)) is time needed to serve passenger h with the car 117a, and term Σ_{g∈H}_{_{c}}₍ₜ₎[W_{c}(g|H_{c}(t)∪h)−W_{c}(g|H_{c}(t))] accounts for the increase in the waiting time for the passenger h.

As defined herein, future passengers are those passengers that have not made a request for service. The set of possible future requests can be defined as

$${{H}^{⋁}}_{j} ( t ) ≡ \{ {h}_{1} , {h}_{2} , … , {h}_{i} , {{h}^{⋁}}_{j , i + 1} , {{h}^{⋁}}_{j , i + 2} , … , {{h}^{⋁}}_{j , {m}_{j}} \} .$$

The set of possible future requests may also be referred to as continuation sets. An optimal Cumulative Waiting Time (CWT) may be determined for each continuation set as

$$W ( {{H}^{⋁}}_{j} ( t ) ) = {\sum }_{c = 1}^{C} {W}_{c} ( {{H}^{⋁}}_{jc} ( t ) \vert {{H}^{⋁}}_{jc} ( t ) ) = {\sum }_{c = 1}^{C} {\sum }_{h ∈ {{H}^{⋁}}_{jc} ( t )}^{} {W}_{c} ( h \vert {{H}^{⋁}}_{jc} ( t ) ) ,$$

where \check{H}_{jc}(t) denotes a subset of continuation set \check{H}ⱼ(t) (of passengers) assigned to the car 117a. Average Waiting Time (AWT) for that assignment can be determined as

$$\frac{1}{M} {\sum }_{j = 1}^{M} \frac{W ( {{H}^{⋁}}_{j} ( t ) )}{{m}_{j}} .$$

Further, the assignment is determined by minimizing the AWT over candidate partitions of the continuation sets. To that end, either an exact or an approximate algorithm can be applied.

Further, let S^{(ξ)}=(p₁^{(ξ)}, p₂^{(ξ)}, . . . , p_{nξ}^{(ξ)} be ξth training trajectory, where p_{κ}^{(ξ)} denotes a grid index of position for kth recording of the trajectory S^{(ξ)}, and a last entry p_{nξ}^{(ξ)} denotes a grid index (or tessellation index) of the position at the destination, ∀κ=1, . . . , n_{ξ}, ξ=1, . . . , Nₜᵣₐᵢₙ. A set of training trajectories {S^{(ξ)}; ξ=1, . . . , Nₜᵣₐᵢₙ} may be obtained from historical recordings extracted from the sensors (such as, a camera installed in the environment). Let a prediction duration T denotes a length of a time interval for potential future arrivals that are desired to be included in the generation of the set of possible future requests. The prediction duration T may be selected either small or large, depending on availability of computational resources. On each floor, sensors monitor movements of persons up to the current time t, and the processor 123 determines a set of the partial trajectories (e.g. the partial trajectory 101 and the like) of candidate future arrivals within time interval [t,t+T].

Let Š^{(ζ)}=(\check{p}₁^{(ζ)}, \check{p}₂^{(ζ)}, . . . , \check{p}_{nζ}^{(ζ)}) denote ζth such partial trajectory, where \check{p}_{τ}^{(ζ)} denotes the grid index of the position for ιth recording of the trajectory Š^{(ζ)}, ∀ι=1, . . . , n_{ζ}, ζ=1, . . . , Nₜₑₛₜ.

Further, for an input partial trajectory Š^{(ζ)}, an actual output of the NTMM 207 is a probability distribution P^{(ζ)}(ω) over a set Ω of all candidate grid indices of positions. Let Ω′ denote a subset of Ω representing the grid indices of positions corresponding to doors of elevator cars on that floor. Further, a set of probabilities {P^{(ζ)}(ω); ω∈Ω′} for the subset Ω′ may be extracted to generate the continuation sets. Based on predictions for the partial trajectory Š^{(ζ)}, different continuations of the arrival stream can then be formed using probabilistic information in {P^{(ζ)}(ω); ω∈Ω′} by means of Monte Carlo simulation. A complete continuation set and further multiple continuation sets are then obtained by taking predictive information of all the partial trajectories available, {Š^{(ζ)}, ζ=1, . . . , Nₜₑₛₜ} into account.

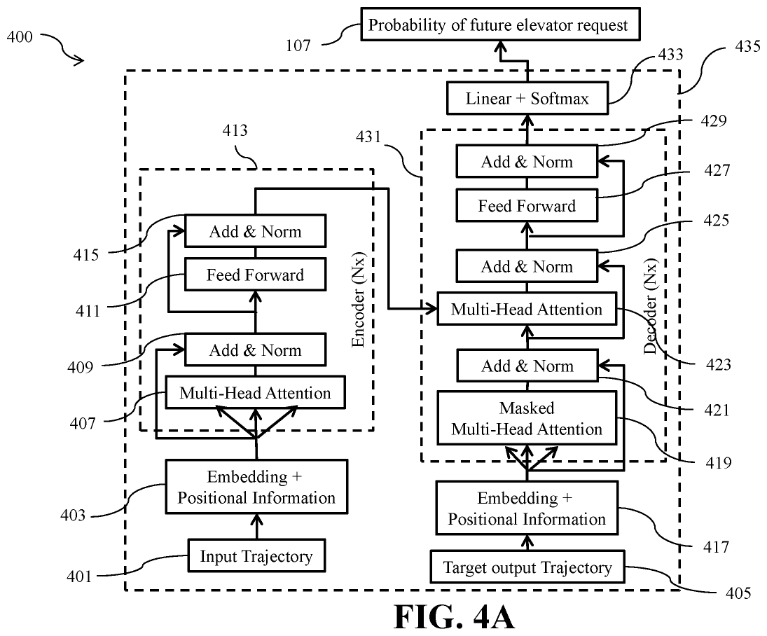

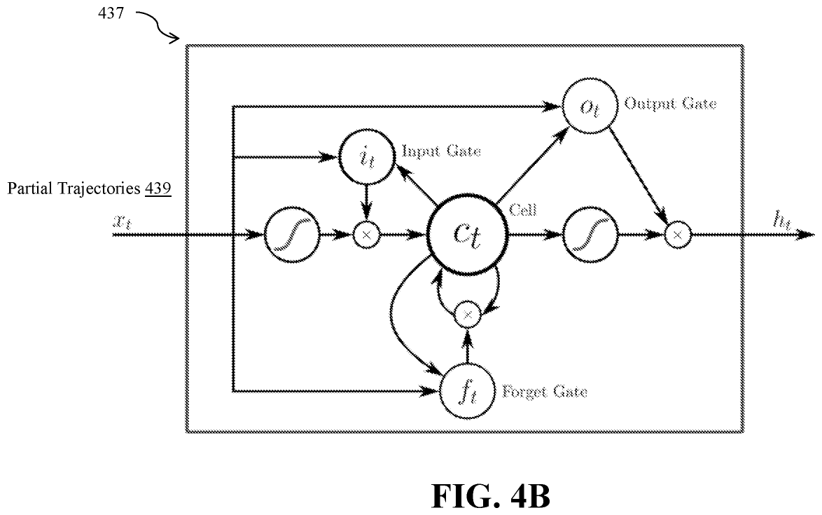

Further, in an embodiment, to obtain the probability of the future elevator request 107, the processor 123 processes the partial trajectory 101 with the transformer architecture based neural network. The transformer architecture based neural network is described below in FIG. 4A.

FIG. 4A shows a block diagram 400 illustrating components of a transformer architecture based neural network 435, according to some embodiments of the present disclosure. The transformer architecture based neural network 435 may include an encoder 413 including a stack of N encoder blocks and a decoder 431 including a stack of N decoder blocks that may further include stack of self-attention and fully connected feed forward layer components in such a way that the transformer architecture based neural network 435 uses a positional encoding and an attention mechanism that enables parallelization.

Some embodiments are based on the realization that an attention mechanism of transformer architecture based neural network 435 enables modeling of dependencies of elements in a sequence without consideration of their distances such advantages of the transformer architecture based neural network 435 are not limited to speech related application, and also true for the extended destination prediction tasks.

As shown in FIG. 4A, initially, an input trajectory 401 (such as the partial trajectory 101) passes through an embedding and positional encoding block 403 where input tokens may be converted to d_{model}-dimensional vectors by an embedding layer, where the input tokens may be discrete elements. Further, order information about the elements of the input trajectory 401 may be obtained using the positional encoding, and is then combined with an embedding vector to obtain a new vector via a summation operation. Further, the new vector may be passed into through a multi-head attention block 407. Attention in the encoder 413 may be used as a means for referencing other tokens in the input trajectory 401 when attempting to encode a specific token.

The multi-head attention block 407 may include an array of scaled-dot product attention components, where an attention function may be calculated based on a data matrix X. The data matrix may be projected using three different matrices that are learned in training, and projected matrices Q, K, and V are obtained which represent queries, keys, and values, respectively.

In some embodiments, the attention may be then calculated as:

Attention(Q,K,V)=softmax(QK^{T}/\sqrt{dₖ})×V

where dₖ is a number of columns of the K matrix.

In some embodiments, multi-head attention mechanism involves calculating multiple attention functions with different learned projections in order to yield improved representation performance.

Further, an addition and normalization block 409 in the encoder 413 may comprise residual connection along with a Layer Normalization (RLN) which may connect an input to the multi-head attention block 407 with an output of the multi-head attention block 407, add them, and then normalize. Resulting elements may further pass through a feed forward sublayer 411 followed by another addition and normalization block 415 comprising RLN connection on its way out of the encoder 413. The addition and normalization block 415 may connect the input to feed forward layer 411 with output of the feed forward layer 411, add them, and then normalize.

Further, a target output trajectory 405 may pass through embedding and positional encoding block 417, which may be similar to embedding and positional encoding block 403, before entering a masked multi-head attention block 419. The masked multi-head attention block 419 element may be similar to the multi-head attention block 407 of the encoder 413 except that the target output trajectory 405 is masked such that the masked multi-head attention block 419 may only refer to preceding output trajectory positions. Further, an addition and normalization block 421 comprising residual connection along with a RLN may connect the input to the masked multi-head attention block 419 with output of the masked multi-head attention block 419, add them, and then normalize.

After the addition and normalization block 421, another multi-head attention block 423 may exist which may be similar to the multi-head attention block 407 of the encoder 413 except that the multi-head attention block 423 uses information from the encoder output as additional input in calculation of attention.

Further, another addition and normalization block 425 may connect the input to the multi-head attention block 423 with output of the multi-head attention block 423, add them, and then normalize. Resulting elements may further pass through a feed forward sublayer 427 followed by another addition and normalization block 429 on its way out of the decoder 431. The addition and normalization block 429 may connect the input to feed forward layer 427 with output of the feed forward layer 427, add them, and then normalize.

Outside of the decoder 431, a linear layer and softmax block 433 may exist that may take the output of the decoder 431 and create a logic vector over all possible output elements. Further, the linear layer and softmax block 433 may perform a softmax operation to convert the values in the logic vectors to output the probability of future elevator request 107.

Alternatively, the processor 123 processes the partial trajectory 101 with RNN to obtain the probability of the future elevator request 107. Examples of the RNN may include, but are not limited to, Long Short-Term Memory (LSTM) based neural network, Bi-directional Long Short-Term Memory (BiLSTM) based neural network, and the like.

FIG. 4B illustrates LSTM based neural network 437, according to an embodiment to the present disclosure. The LSTM based neural network unit 437 includes an input gate, a forget gate, and an output gate. Each of these gates corresponds to a “standard” neuron in a feed-forward (or multi-layer) neural network, that is, each gate computes an activation (using an activation function) of a weighted sum. Further, it, ot, and ft represent activations of respectively the input, output and forget gates, at time step t. Exit arrows from memory cell c to the gates i, o, and f represent peephole connections. The peephole connections denote contributions of the activation of the memory cell c at time step t−1, i.e. the contribution of ct−1. In other words, the gates i, o, and f calculate their activations at time step t (i.e., respectively, it, ot, and ft) also considering the activation of the memory cell c at time step t−1, i.e. ct−1. Single left-to-right arrow exiting the memory cell c is not a peephole connection and denotes ct, and a “×” symbol represent an element-wise multiplication between inputs. Further, the LSTM based neural network 437 includes an application of a differentiable function (like a sigmoid function) to a weighted sum.

In operation, the first LSTM unit receives partial trajectories 439 and pass the hidden state vectors ht on to the following LSTM units and finally to a softmax layer to output the probability of future elevator request 107.

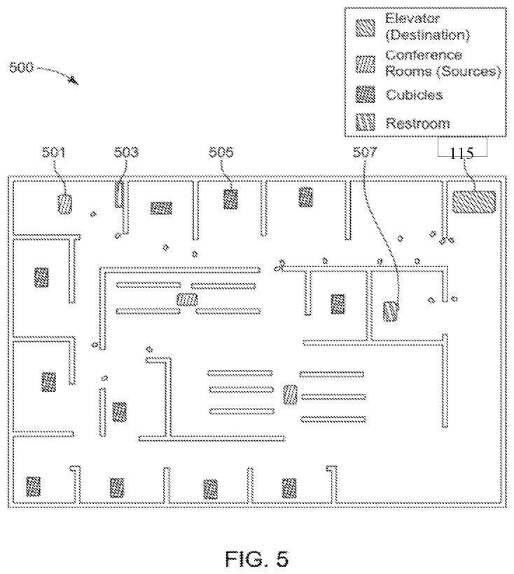

Alternatively, in an embodiment, the processor 123 receives, from the person, an elevator service request via a user device, and generates a set of possible future requests jointly representing the elevator service request and the arrival time distribution. Such an embodiment is described below in FIG. 5.

FIG. 5 shows a schematic illustrating a floor 500 of the building, according to some embodiments of the present disclosure. The floor 500 may include the bank of elevators 115, one or more conference rooms 501, one or more cubicles 505, and restrooms 507. In an embodiment, a user device may be provided in each conference room and each cubicle. For example, a user device 503 is provided in the conference room 501. The user device 503 may include a user interface for submitting the elevator service request for service by the bank of elevators 115. A person residing in the conference room 501 may submit the elevator service request via the user interface of the user device 503. Alternatively, the person may also submit the elevator service request via the user device, such as, a smart phone, a laptop, and the like.

Further, the processor 123 generates a set of possible future requests jointly representing the elevator service request received via the user device 503, and the arrival time distribution 105. The processor 123 optimizes a schedule of the bank of elevators 115 to serve the current elevator requests 111 and the generated set of possible future requests. Based on the optimized schedule, the processor 123 controls the bank of elevators 115.

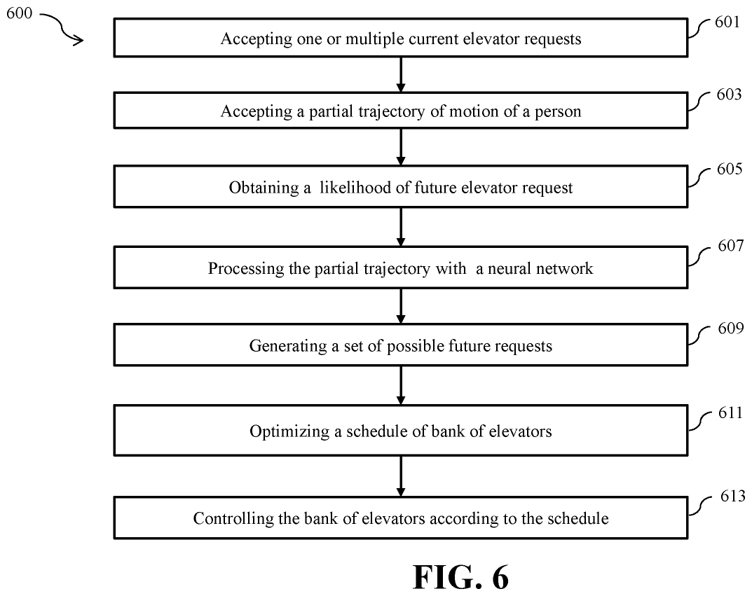

An overall method for controlling the motion of the bank of elevators 115 is described below in FIG. 6.

FIG. 6 shows a block diagram of a method 600 for controlling the motion of bank of elevators 115, according to an embodiment of the present disclosure.

At block 601, the method 600 includes accepting one or multiple current elevator requests 111 from one or multiple passengers. For example, the one or multiple passengers may place a request for the elevator cars (such as, car 117a or the car 117b) by pressing or touching an UP or a DOWN button associated with the bank of elevators 115.

At block 603, the method 600 includes accepting a partial trajectory (e.g., the partial trajectory 101) of a motion of a person moving in an environment serviced by the bank of elevators 115. At block 605, the method 600 includes obtaining a probability of a future elevator request, e.g., the probability of a future elevator request 107.

At block 607, the method 600 includes processing the partial trajectory with a neural network trained to estimate a weighted combination of probability density functions, wherein the weighted combination of probability density functions indicates an arrival time distribution of the person arriving to the elevator by one of multiple paths in the environment. In an embodiment, the neural network corresponds to NTMM 207 described above in FIG. 2.

At block 609, the method 600 includes generating a set of possible future requests jointly representing the probability of the future elevator request and the arrival time distribution. At 611, the method 600 includes optimizing a schedule of the bank of elevators 115 to serve the current requests and the generated set of possible future requests.

At block 613, the method 600 includes controlling the bank of elevators 115 according to the optimized schedule.

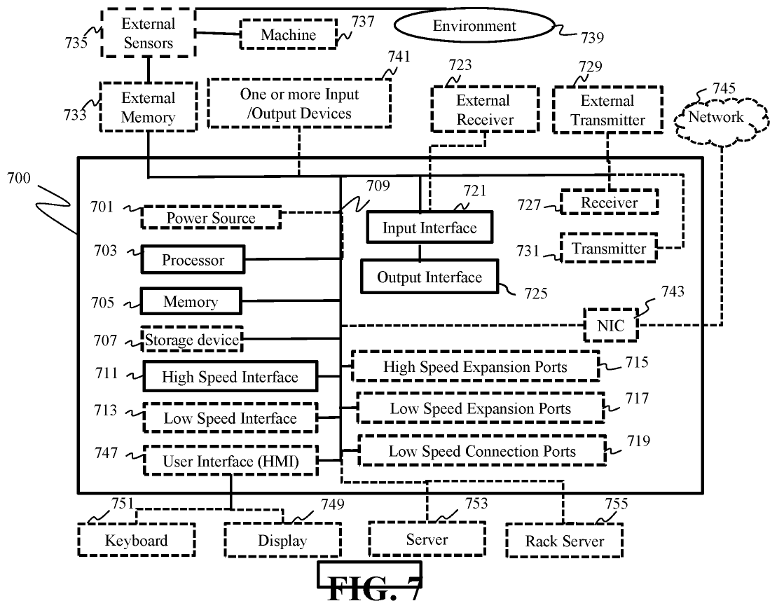

FIG. 7 is a schematic illustrating a computing device 700 for implementing the method 600 and the control system 121 of the present disclosure. The computing device 700 includes a power source 701, a processor 703, a memory 705, a storage device 707, all connected to a bus 709. Further, a high-speed interface 711, a low-speed interface 713, high-speed expansion ports 715 and low speed connection ports 717, can be connected to the bus 709. In addition, a low-speed expansion port 719 is in connection with the bus 709. Further, an input interface 721 can be connected via the bus 709 to an external receiver 723 and an output interface 725. A receiver 727 can be connected to an external transmitter 729 and a transmitter 731 via the bus 709. Also connected to the bus 709 can be an external memory 733, external sensors 735, machine(s) 737, and an environment 739. Further, one or more external input/output devices 741 can be connected to the bus 709. A network interface controller (NIC) 743 can be adapted to connect through the bus 709 to a network 745, wherein data or other data, among other things, can be rendered on a third-party display device, third party imaging device, and/or third-party printing device outside of the computer device 700.

The memory 705 can store instructions that are executable by the computer device 700 and any data that can be utilized by the methods and systems of the present disclosure. The memory 705 can include random access memory (RAM), read only memory (ROM), flash memory, or any other suitable memory systems. The memory 705 can be a volatile memory unit or units, and/or a non-volatile memory unit or units. The memory 705 may also be another form of computer-readable medium, such as a magnetic or optical disk.

The storage device 707 can be adapted to store supplementary data and/or software modules used by the computer device 700. The storage device 707 can include a hard drive, an optical drive, a thumb-drive, an array of drives, or any combinations thereof. Further, the storage device 707 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 703), perform one or more methods, such as those described above.

The computing device 700 can be linked through the bus 709, optionally, to a display interface or user Interface (HMI) 747 adapted to connect the computing device 700 to a display device 749 and a keyboard 751, wherein the display device 749 can include a computer monitor, camera, television, projector, or mobile device, among others. In some implementations, the computer device 700 may include a printer interface to connect to a printing device, wherein the printing device can include a liquid inkjet printer, solid ink printer, large-scale commercial printer, thermal printer, UV printer, or dye-sublimation printer, among others.

The high-speed interface 711 manages bandwidth-intensive operations for the computing device 700, while the low-speed interface 713 manages lower bandwidth-intensive operations. Such allocation of functions is an example only. In some implementations, the high-speed interface 711 can be coupled to the memory 705, the user interface (HMI) 747, and to the keyboard 751 and the display 749 (e.g., through a graphics processor or accelerator), and to the high-speed expansion ports 715, which may accept various expansion cards via the bus 709. In an implementation, the low-speed interface 713 is coupled to the storage device 707 and the low-speed expansion ports 717, via the bus 709. The low-speed expansion ports 717, which may include various communication ports (e.g., USB, Bluetooth, Ethernet, wireless Ethernet) may be coupled to the one or more input/output devices 741. The computing device 700 may be connected to a server 753 and a rack server 755. The computing device 700 may be implemented in several different forms. For example, the computing device 700 may be implemented as part of the rack server 755.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

1. A control system for controlling motion of a bank of elevators, comprising: at least one processor; and a memory having instructions stored thereon that cause the at least one processor of the control system to:
accept one or multiple current elevator requests for service by the bank of elevators;
accept a partial trajectory of a motion of a person moving in an environment serviced by the bank of elevators;
obtain a probability of a future elevator request;
process the partial trajectory with a neural network trained to estimate a weighted combination of probability density functions, wherein the weighted combination of probability density functions indicates an arrival time distribution of the person arriving to the bank of elevators by one of multiple paths in the environment;
generate a set of possible future requests jointly representing the probability of the future elevator request and the arrival time distribution;
optimize a schedule of the bank of elevators to serve the one or multiple current elevator requests and the set of possible future requests; and
control the bank of elevators according to the schedule.

2. The control system of claim 1, wherein the neural network is a Neural Travel-time Mixture Model (NTMM).

3. The control system of claim 2, wherein the NTMM is trained based on a dataset including coordinates of origins and destinations, and durations of trajectories corresponding to different persons.

4. The control system of claim 3, wherein the durations of trajectories correspond to the same person at different times.

5. The control system of claim 3, wherein the processor is further configured to retrain the NTMM based on a new dataset including durations of updated trajectories corresponding to different persons.

6. The control system of claim 1, wherein, to obtain the probability of the future elevator request, the processor is further configured to process the partial trajectory with a transformer architecture based neural network.

7. The control system of claim 1, wherein, to obtain the probability of the future elevator request, the processor is further configured to process the partial trajectory with a Recurrent Neural Network (RNN).

8. The control system of claim 1, wherein the processor is further configured to:
receive, from the person, an elevator service request via a user device; and
generate a set of possible future requests jointly representing the elevator service request and the arrival time distribution.

9. A method for controlling motion of a bank of elevators, the method comprising:
accepting one or multiple current elevator requests for service by the bank of elevators;
accepting a partial trajectory of a motion of a person moving in an environment serviced by the bank of elevators;
obtaining a probability of a future elevator request;
processing the partial trajectory with a neural network trained to estimate a weighted combination of probability density functions, wherein the weighted combination of probability density functions indicates an arrival time distribution of the person arriving to the bank of elevators by one of multiple paths in the environment;
generating a set of possible future requests jointly representing the probability of the future elevator request and the arrival time distribution;
optimizing a schedule of the bank of elevators to serve the one or multiple current elevator requests and the set of possible future requests; and
controlling the bank of elevators according to the schedule.

10. The method of claim 9, wherein the neural network is a Neural Travel-time Mixture Model (NTMM).

11. The method of claim 10, wherein the NTMM is trained based on a dataset including coordinates of origins and destinations, and durations of trajectories corresponding to different persons.

12. The method of claim 11, wherein the durations of trajectories correspond to the same person at different times.

13. The method of claim 11, wherein the method further comprises retraining the NTMM based on a new dataset including durations of updated trajectories corresponding to different persons.

14. The method of claim 9, wherein, to obtain the probability of the future elevator request, the method further comprises processing the partial trajectory with a transformer architecture based neural network.

15. The method of claim 9, wherein, to obtain the probability of the future elevator request, the method further comprises processing the partial trajectory with a Recurrent Neural Network (RNN).

16. The method of claim 9, wherein the method further comprises:
receiving, from the person, an elevator service request via a user device; and
generating a set of possible future requests jointly representing the elevator service request and the arrival time distribution.

17. A non-transitory computer-readable storage medium embodied thereon a program executable by a processor for performing a method for controlling motion of a bank of elevators, the method comprising:
accepting one or multiple current elevator requests from one or multiple passengers for service by the bank of elevators;
accepting a partial trajectory of a motion of a person moving in an environment serviced by the bank of elevators;
obtaining a probability of a future elevator request;
processing the partial trajectory with a neural network trained to estimate a weighted combination of probability density functions, wherein the weighted combination of probability density functions indicates an arrival time distribution of the person arriving to the bank of elevators by one of multiple paths in the environment;
generating a set of possible future requests jointly representing the probability of the future elevator request and the arrival time distribution;
optimizing a schedule of the bank of elevators to serve the one or multiple current elevator requests and the set of possible future requests; and
controlling the bank of elevators according to the schedule.

18. The non-transitory computer-readable storage medium of claim 17, wherein the neural network is a Neural Travel-time Mixture Model (NTMM).

19. The non-transitory computer-readable storage medium of claim 17, wherein the NTMM is trained based on a dataset including coordinates of origins and destinations, and durations of trajectories corresponding to different persons.

20. The non-transitory computer-readable storage medium of claim 19, wherein the method further comprises retraining the NTMM based on a new dataset including durations of updated trajectories corresponding to different persons.
